(19) United States
(12) Patent Application Publication
(10) Pub. No.: US 2013/0066862 A1
(43) Pub. Date: Mar. 14, 2013

(54) MULTI-FACTOR CORRELATION OF INTERNET CONTENT RESOURCES

(71) Applicants: Richard Harvey James Orr, Redmond, WA (US); Dirk Myers, Kirkland, WA (US); Kimberly Maughan Saunders, Kirkland, WA (US); Guillermo Proano, Sammamish, WA (US); Edward James Lehman, Sammamish, WA (US); Maria Balsamo, Bellevue, WA (US)

(72) Inventors: Richard Harvey James Orr, Redmond, WA (US); Dirk Myers, Kirkland, WA (US); Kimberly Maughan Saunders, Kirkland, WA (US); Guillermo Proano, Sammamish, WA (US); Edward James Lehman, Sammamish, WA (US); Maria Balsamo, Bellevue, WA (US)

(73) Assignee: MICROSOFT CORPORATION, Redmond, WA (US)

(21) Appl. No.: 13/230,800

(22) Filed: Sep. 12, 2011

(51) Int. Cl. G06F 17/30

(52) U.S. Cl. 707/728; 707/741; 707/769; 707/723; 707/E17.002; 707/E17.014

(57) ABSTRACT

Embodiments are directed to efficiently correlating internet resources and to providing relevant content to a user. In an embodiment, a computer system gathers portions of information from multiple different resources and organizes the gathered information into different indices according to at least one of the following data axes: author, topic and source. The computer system computes correlations between the organized information across the data axes so that each portion of information has relationship information linking it to other portions of organized information. The computer system also intelligently learns which other informational items are to be searched for based on the computed correlations and returns the additional data relevant to the gathered data.

### BACKGROUND

Computers have become highly integrated in the workforce, in the home, in mobile devices, and many other places. Computers can process massive amounts of information quickly and efficiently. Software applications designed to run on computer systems allow users to perform a wide variety of functions including business applications, schoolwork, entertainment and more. Software applications are often designed to perform specific tasks, such as word processor applications for drafting documents, or email programs for sending, receiving and organizing email.

As such, software applications allow users to create all different kinds of information. This information may be shared with others via internet web pages, blogs, social media posts, text messages or other means of communication. This information may have varying degrees of value, particularly in different fields of knowledge. For instance, a user may be very knowledgeable about a certain topic. This user may post information relating to that topic in various blogs, forums or other venues. This user may also know other people or other websites that are knowledgeable about that topic. These users and websites may, in turn, know or be linked to other venues for sharing information. Effectively organizing this information and its interrelations with other information is difficult at best.

### BRIEF SUMMARY

Embodiments described herein are directed to efficiently correlating internet resources and to providing relevant content to a user. In one embodiment, a computer system gathers portions of information from multiple different resources and organizes the gathered information into different indices according to at least one of the following data axes: author, topic and source. The computer system computes correlations between the organized information across the data axes so that each portion of information has relationship information linking it to other portions of organized information. The computer system also intelligently learns which other informational items are to be searched for based on the computed correlations and returns the additional data relevant to the gathered data.

In another embodiment, a computer system accesses various indices of organized information which were organized according to interrelationships between any two of the following data axes: author, topic and source. The computer system computes correlations between the organized information across the data axes so that each portion of information has relationship information linking it to other portions of organized information. The computer system receives from a user an identifier (or partial identifier) that is indexed on at least one of the data axes and initiates a search for information items related to the received identifier specified along at least one of the data axes. The computer system also provides the results of the search to the user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a computer architecture in which embodiments of the present invention may operate including efficiently correlating internet resources and providing relevant content to a user.

FIG. 2 illustrates a flowchart of an example method for efficiently correlating internet resources.

FIG. 3 illustrates a flowchart of an example method for providing relevant content to a user.

FIGS. 4A-4E illustrate various portions of information being organized according to author, topic, source and by link.

### DETAILED DESCRIPTION

Embodiments described herein are directed to efficiently correlating internet resources and to providing relevant content to a user. In one embodiment, a computer system gathers portions of information from multiple different resources and organizes the gathered information into different indices according to at least one of the following data axes: author, topic and source. The computer system computes correlations between the organized information across the data axes so that each portion of information has relationship information linking it to other portions of organized information. The computer system also intelligently learns which other informational items are to be searched for based on the computed correlations and returns the additional data relevant to the gathered data.

In another embodiment, a computer system accesses various indices of organized information which were organized according to interrelationships between any two of the following data axes: author, topic and source. The computer system computes correlations between the organized information across the data axes so that each portion of information has relationship information linking it to other portions of organized information. The computer system receives from a user an identifier (or partial identifier) that is indexed on at least one of the data axes and initiates a search for information items related to the received identifier specified along at least one of the data axes. The computer system also provides the results of the search to the user.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions in the form of data are computer storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM, solid state drives (SSDs) that are based on RAM, Flash memory, phase-change memory (PCM), or other types of memory, or other optical disk storage, magnetic disk storage or other magnetic storage devices, or any other medium which can be used to store desired program code means in the form of computer-executable instructions, data or data structures and which can be accessed by a general purpose or special purpose computer.

A “network” is defined as one or more data links and/or data switches that enable the transport of electronic data between computer systems and/or modules and/or other electronic devices. When information is transferred or provided over a network (either hardwired, wireless, or a combination of hardwired or wireless) to a computer, the computer properly views the connection as a transmission medium. Transmissions media can include a network which can be used to carry data or desired program code means in the form of computer-executable instructions or in the form of data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”), and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems that are linked (either by hardwired data links, wireless data links, or by a combination of hardwired and wireless data links) through a network, each perform tasks (e.g. cloud computing, cloud services and the like). In a distributed system environment, program modules may be located in both local and remote memory storage devices.

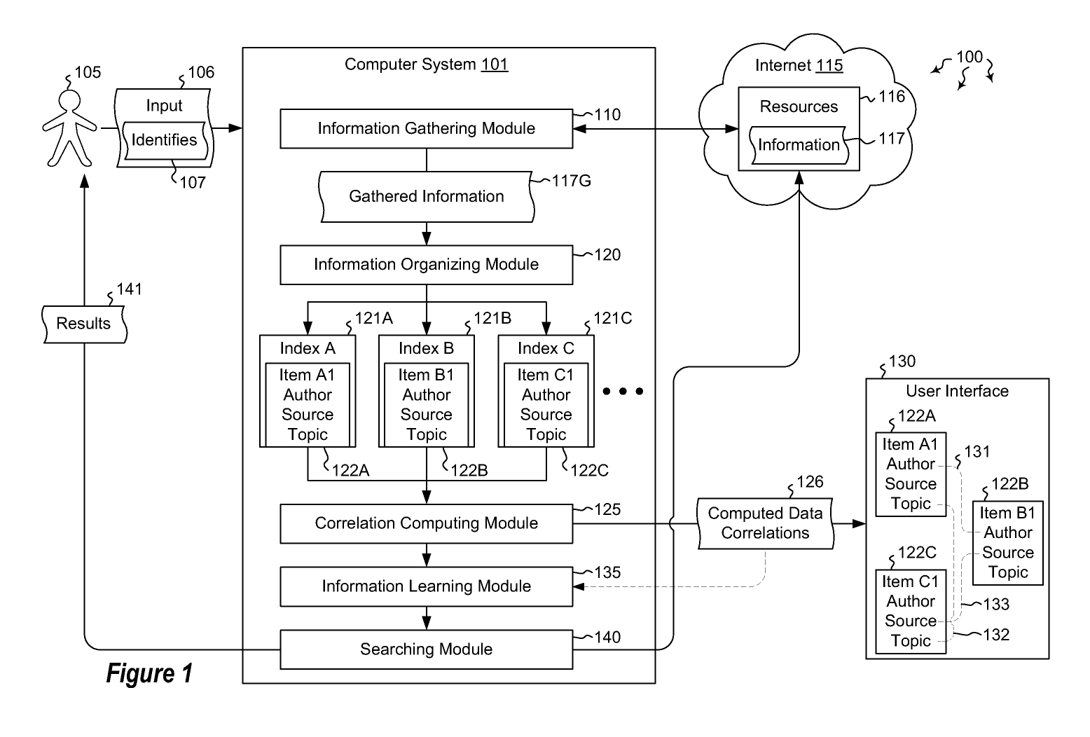

FIG. 1 illustrates a computer architecture 100 in which the principles of the present invention may be employed. Computer architecture 100 includes computer system 101. Computer system 101 may be any type of local or distributed computing system, including a cloud computing system. The computer system may be communicatively connected to other computer systems, including the internet 115. The computer system may run software applications, each of which may have its own user interface 130. The user interface may allow user 105 to interact with a particular software program on the computer system. For instance, the user may use a web browser user interface to browse web pages and use other resources on the internet.

Content resources exist on the internet in many different forms. These resources range from web pages to instant communication tools, to forums and blogs to picture and video sharing sites. These resources are typically composed of unstructured data such as text, audio, video, photographs, and so on. Embodiments of the invention as claimed provide correlation and context to standalone content resources. These resources may be correlated in many different ways, three of which are explained in greater detail below. The first is by topic, the second is by author and the third is by source. Resources may also be correlated by linking and other various means.

Correlation, as the term is used herein, refers to how content resources are related to one another. Correlation is often expressed as a percentage of certainty, as to how confident the correlation system is that two resources are related. The system represents correlation of each correlation factor as a degree of confidence. The system explicitly manages this degree of confidence for each factor, as well as an overall degree of confidence in correlation.

In some embodiments, separate correlation factors are brought together (or are considered together) to increase the overall confidence in correlation. Where many different factors suggest a possible correlation at a low degree of confidence, the overall confidence of correlation increases. Likewise, a single correlation factor with a high degree of confidence that is not supported by other correlation factors yields low overall confidence.

The correlation system (as generally shown in FIG. 1) represents correlation with a degree of certainty or degree of confidence, which allows users to determine thresholds for considering a correlation to be significant. As an example, a business manager may want to see resources that describe dissatisfaction with a competitor from people who are sympathetic to that competitor in the official publication vehicles for that competitor. In another example, an engineer may want to see technical answers on a particular topic that have been submitted by people with a strong track record of useful answers on that topic, wherever on the internet those answers appear.

The correlation system allows a system administrator or manager to confirm a correlation. This increases the degree of confidence for that particular correlation. It should be noted that the system may infer several correlations for a given factor, and an administrator can confirm all, none, or any combination of correlations. The correlation system may also use manager (or other user) confirmation of correlations to adjust confidence in similar correlations that have not yet been confirmed. By explicitly identifying and managing these aspects of correlation, as well as relating these aspects together, a more flexible and reliable correlation of internet resources may be provided. In some cases, tracking social media may be tracked and correlated, as explained further below.

Topic analysis, as used herein, involves analyzing a resource for the explicit content of the resource. This involves textual analysis. This may also involve pre-processing to arrive at a text (for example, applying speech-to-text for a video). In some cases, textual analysis may also involve machine translation of resources in diverse languages to a common language for analysis. Topic analysis various types of matching including the following: explicit term matching which, in cases where resources use the same terms explicitly, the correlation system correlates resources as related by those terms. Synonym or equivalent term matching is where the correlation system understands equivalence of some terms (synonyms), and can correlate resources based on term equivalence. This also allows for variations in spelling, regional differences in terminology, and so on.

Triple (subject-verb-object) matching is where the correlation system can analyze subject/verb/object triples within a resource and correlate resources based on similar triples. Matching within the triples can be done by either explicit term matching or equivalent term matching. Approximate matching (subject/object, synonym, etc.) is where the correlation system can use thresholds of relevance to correlate items in cases where two resources are similar, but not identical. The system tracks a score for the relevance of an association, allowing analysis and consumption of the data based on a specific threshold. Semantic matching is where the correlation system can use semantic analysis of two resources to determine that they are correlated, independent of the terminology or sentence structure used.

Turning now to authorship analysis, authorship analysis may include a number of techniques. In practice, most of the inferences performed by the correlation system will use a combination of techniques to improve the accuracy of inference. Authorship analysis may include any one or more of the following types of analysis: explicit content declaration may be used where resources that are published by the same account or are reliably tagged with the same account are explicitly considered to be published by the same author, and are correlated in that way. Explicit profile declaration is where the correlation system allows users of the system to declare the accounts that they use. In cases where resources are published by accounts declared to be part of the same profile, the correlation system correlates the resources as being published by the same author.

Explicit administrative declaration is where the correlation system allows administrators or system managers to declare accounts to be owned by the same person. In this case, a system administrator explicitly correlates accounts. This correlation may be based on suggestions provided by inference, or may be based on knowledge external to the system. Inference based on (profile) metadata is where resources that are published by different accounts can be correlated to the same author in cases where the correlation system can reliably determine that the two accounts have the same author. As an example, if two accounts refer to each other in a way that requires access to both accounts, the system infers that items from the two accounts are published by the same author.

Inference based on social promotion may be used in cases where accounts consistently refer to each other and consistently carry the earliest cross-reference observed. The correlation system can infer that the accounts have the same author, and one account is being used to promote the other account. Inference based on textual analysis and topic is where resources published by different accounts that consistently discuss similar topics and share textual aspects that are similar to each other, but different than other accounts, can be inferred to be published by the same author. Textual analysis includes word choice, phrasing, readability index, sentence structure, and so on. The correlation system can also detect regional variations (for example, American versus British spellings) to help infer authorship.

Continuing the various forms of authorship analysis, inference based on avatar pictures or video may include resources published by an account with an avatar picture attached or published as video which can be subject to face recognition. Where face recognition has a high probability that two accounts use the same face, and that face is not widely known externally (e.g. is not a movie star), the correlation system can infer that the accounts are the same author. Inference based on social graph may be used in cases where explicit (profile) or implicit social graph information is available. The system can infer that two accounts with no correlation across channels that interact with the same people across channels are the same person. For example, if Bob interacts with Alice and Ted and unknown account X in one channel, and Alice and Ted and unknown account Y in another channel, the system can infer that account X and account Y may be the same person).

Inference based on textual reference may be used in cases where a natural language name is consistently used in combination with an account. The correlation system can infer that the account is associated with that person. Inference based on published location may be used in cases where resources are consistently published from the same location, particularly in cases where the location of multiple possibly-correlated resources changes simultaneously. The correlation system can infer that the resources are published by the same person. Inference based on activity patterns and topics may be used in cases where activity is clustered at certain times of day. The system can infer time zone location to help with correlation. In addition, the system can use semantic/topic information to infer work hours versus non-work hours during active times. Disambiguation of ambiguous authorship may be used in cases where a publishing system allows multiple authors to use the same name online, the system can use stylistic clues, topical clues, posting behavior (frequency, time, length of post, etc.) to disambiguate between authors.

Author inference techniques can be combined. For example, someone posting a picture of a conference attendee tagged with that person's name can add weight to facial recognition for that person in video and avatar recognition. Likewise, inference started by analysis of style that suggests that two resources may have been authored by the same person could be strengthened if other resources refer to the resources as having been created by that person. Another example would be technical help on a certain product from two accounts suddenly moving to a different geographic location for one week, where no other accounts discussing that product move.

Source analysis describes characteristics of publication channels and the resources published in those channels. Source analysis techniques may include the following: site identity, which may be used where resources published on the same site are correlated by virtue of being published on the same site. Site usage patterns may include resources published on sites that have the same usage patterns (for example, question and answer sites versus sites that publish technical articles). Site topic patterns may be used to determine correlations between resources published on sites that discuss similar topics. Site locale may be used to determine correlations between resources published on sites with a similar geographic locale. Site actions may correlate resources published on sites that allow similar actions. For example, sites that allow free-text editing (wild sites) may be correlated using this technique.

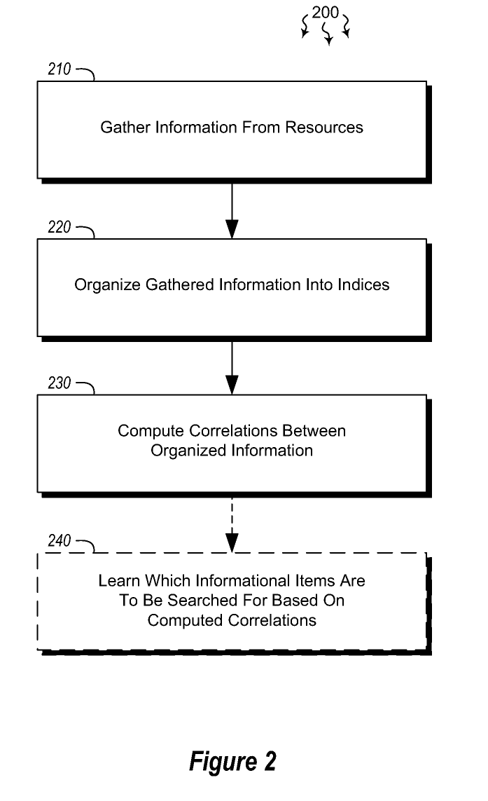

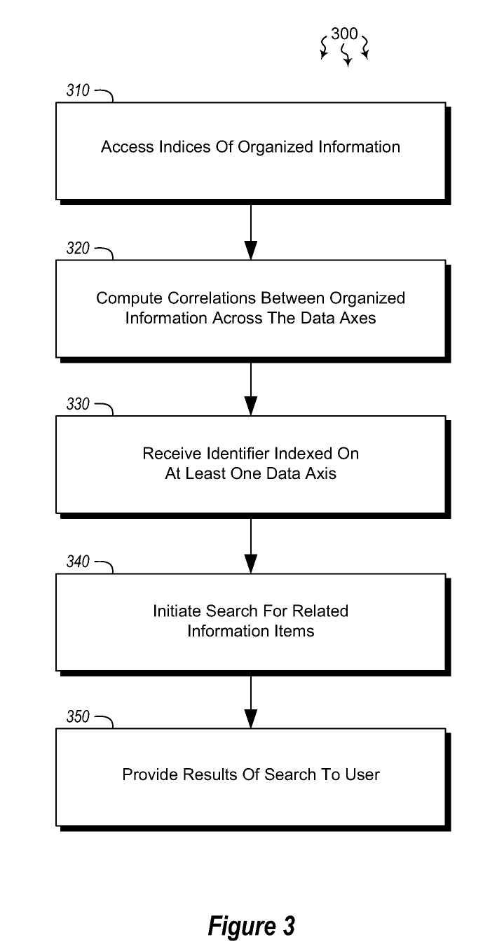

Resources may also be correlated with resources that they link to. Various correlation techniques using linking may include direct linking Direct linking may be used when one resource links to another directly. When such is the case, these resources are correlated. Similarly, resources may be identified as correlated when linked through proxy or link shorteners. Another correlation technique is linking through mutual linking. This may be used when two resources (A, B) link to the same third resource (C), resources A & B are correlated through linking to C. Linking through indirect linking may be used when a resource A links to a resource B that links to a resource C, resource A is correlated to resource C through indirect linking. Linking through textual reference may show correlation when one resource refers to another in text. For example, a resource that refers to another resource by title and author is correlated to that resource regardless of whether there is an explicit link. Correlation using these techniques will be explained further below with regard to methods 200 and 300 of FIGS. 2 and 3, and in regard to the correlation system of FIG. 1.

In view of the systems and architectures described above, methodologies that may be implemented in accordance with the disclosed subject matter will be better appreciated with reference to the flow charts of FIGS. 2 and 3. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 2 illustrates a flowchart of a method 200 for efficiently correlating internet resources. The method 200 will now be described with frequent reference to the components and data of environment 100.

Method 200 includes an act of gathering one or more portions of information from a plurality of different resources (act 210). For example, information gathering module 110 may gather information 117 from various resources 116 on the internet 115. These resources may include web sites, blogs, forums, social media websites, instant communication tools, video and picture sharing sites and other web resources. Data including text, video, audio, pictures or other data gathered from those resources may simply be referred to information herein. This gathered information 117G may then be organized by the correlation system.

Method 200 includes an act of organizing the gathered information into multiple different indices according to at least one of the following data axes: author, topic and source (act 220). For example, information organizing module 120 may organize the gathered information 117G into various indices. These indices may include index A (121A), index B (121B), index C (121C) and other indices (as indicated by the ellipses). Although three indices are shown, substantially any number of indices may be used. Within each index, each item of gathered information (e.g. items A1 (122A), B1 (122B) and C1 (122C) may be organized along data axes corresponding to author, source and/or topic. In some cases, the information may be organized along each data axis according to time of creation. Accordingly, a forum posting, for example, may be tagged as a forum posting, attributed to an author with a certain picture or avatar, gathered from a particular source at a certain time and related to a certain topic.

The organizing module 120 may use various techniques to organize the information, as mentioned above. The organizing module may organize the gathered information into multiple different indices according to topic using any one or more of the following techniques: explicit term matching, synonym or equivalent term matching, subject-verb-object matching, approximate matching and semantic matching. Similarly, the organizing module may use any one or more of the following to organize information according to authorship: explicit content declaration, explicit profile declaration, explicit administrative declaration, inference based on profile metadata, inference based on social promotion, inference based on textual analysis and topic, inference based on avatar, picture or video, inference based on social graph, inference based on textual reference, inference based on published location, inference based on activity patterns and topics, and disambiguation of ambiguous authorship

Still further, the organizing module may use any one or more of the following techniques to organize the information according to source: site identity, site usage patterns, site topic patterns, site locale, site actions and links to other sources, including direct linking, linking through proxy or link shorteners, linking through mutual linking, linking through indirect linking and linking through textual reference. These organization techniques may be used alone or in combination with other organization techniques. Thus, a given information item (e.g. 122A) may be organized according to any one or more of the above-listed techniques for organization by author, source and/or topic.

Method 200 further includes an act of computing correlations between the organized information across the data axes such that each portion of information has relationship information linking it to other portions of organized information (act 230). For example, correlation computing module 125 may compute correlations (e.g. 131, 132 and 133) between the organized information across the author, topic and/or source data axes. As such, each information item (e.g. 122B) has relationship information linking it to other portions of organized information. The links may indicate correlations between information items' author, source and/or topic. As shown in user interface 130, item A1 (122A) is related to item B1 (122B) by authorship (relationship 131), and to item C1 (122C) by topic (relationship 132). Similarly, item B1 is related to item A1 by authorship (131) and to C1 by source (relationship 133), and item C1 is related to item A1 by topic (132) and to B1 by source (133). As such, information items may be correlated to one another to form a picture of what is happening on the internet specific to a given author, source and/or topic.

When determining the correlations between information items, the correlation computing module may weight each correlation according to one or more of a plurality of weighting factors. As each correlation may be weak or strong, it may be useful to determine how weak or strong a particular relationship is. Many different weighting factors may be used. Explicit names, direct links, explicit declarations of topic may all indicate a stronger correlation, while inferences based on source and user aliases and a general lack of explicit topic may indicate a weaker correlation. Based on the determined weighting for a given relationship, a further search may be performed to solidify the correlation of an information item. The further search may provide additional explicit, implicit and/or behavioral indications of correlation that would strengthen or weaken the determined correlations.

In one example, a computed correlation may create a relationship between an article and an author, between an article reader/responder and the author and further determine, based on the created relationships, the type of relationship between the author and the reader/responder. Thus, if Bob is the author of the article, and Ted (the reader and responder) makes a comment on the article, based on the type of comment or various words in the comment, the correlation system may determine that Bob and Ted have a relationship based around a particular subject matter (e.g. personal, work, sports league, etc.). Any such relationships may be stored in computer system 101 for further use. In some cases, the type of relationship may be confirmed by the author (Bob) and/or the article reader/responder (Ted), thus increasing the strength of that correlation. These relationships may be displayed to a user 105 on user interface 130. In some embodiments, the user interface may allow the user to browse the information items and view the correlations to other items.

Method 200 includes an optional act of intelligently learning which other informational items are to be searched for based on the computed correlations, such that one or more portions of additional data relevant to the gathered data is returned (act 240). For example, information learning module 135 may learn or discover additional information items which should be searched for. For instance, in one example, the intelligent learning may include determining the author of a given article, the readers or followers of that author, what other articles are similar and what other sources mention the article. Another example may include receiving from user 105 one or more keyword topics (e.g. input 106) the user is interested in and in response to the received keyword topics, searching for one or more portions of relevant data, refined by author and source. The search may search for related data using determined correlations, and may discover new correlations during the search. Thus, as data is generated on the internet, that data may be gathered and organized. Correlations between the different data may be computed and used to find other items which may be of use to the user. This will be explained below in regard to method 300 of FIG. 3.

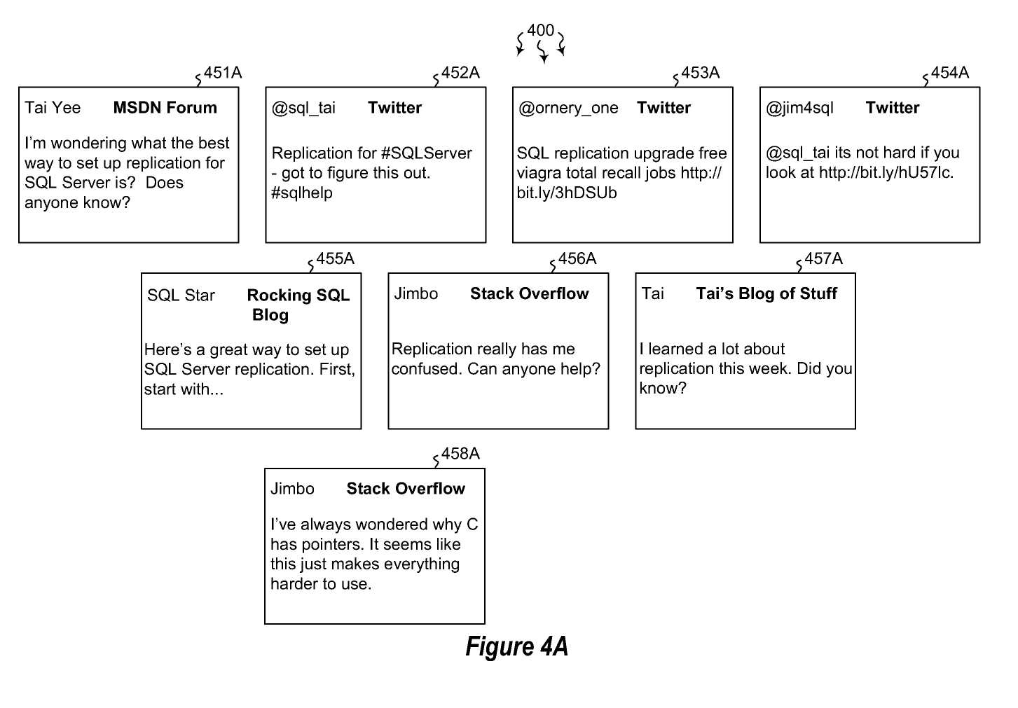

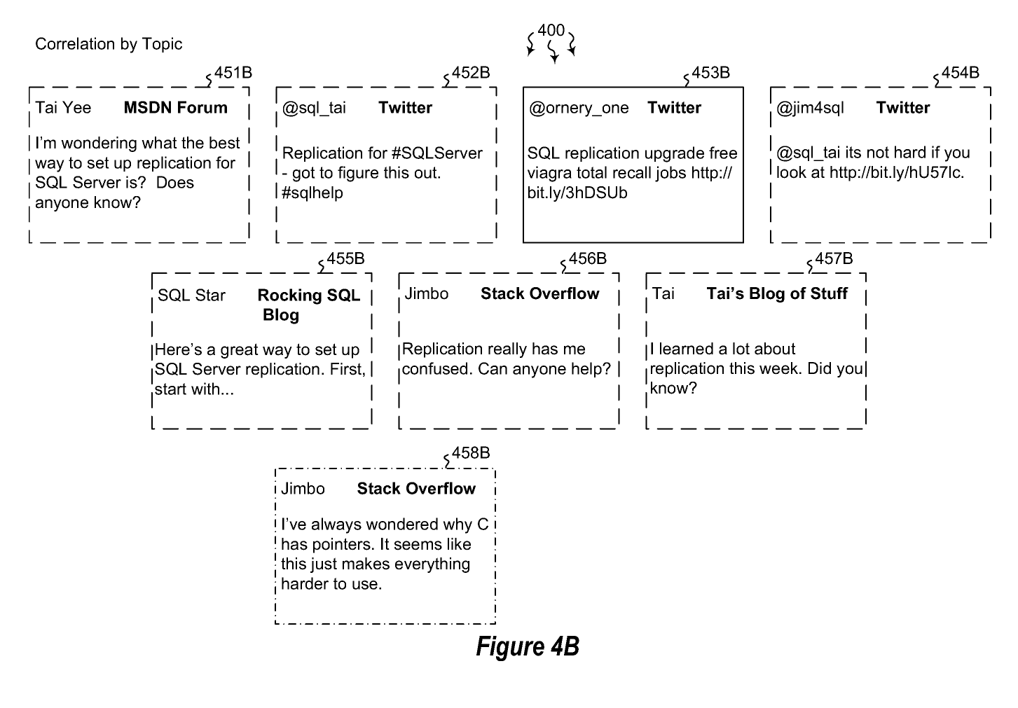

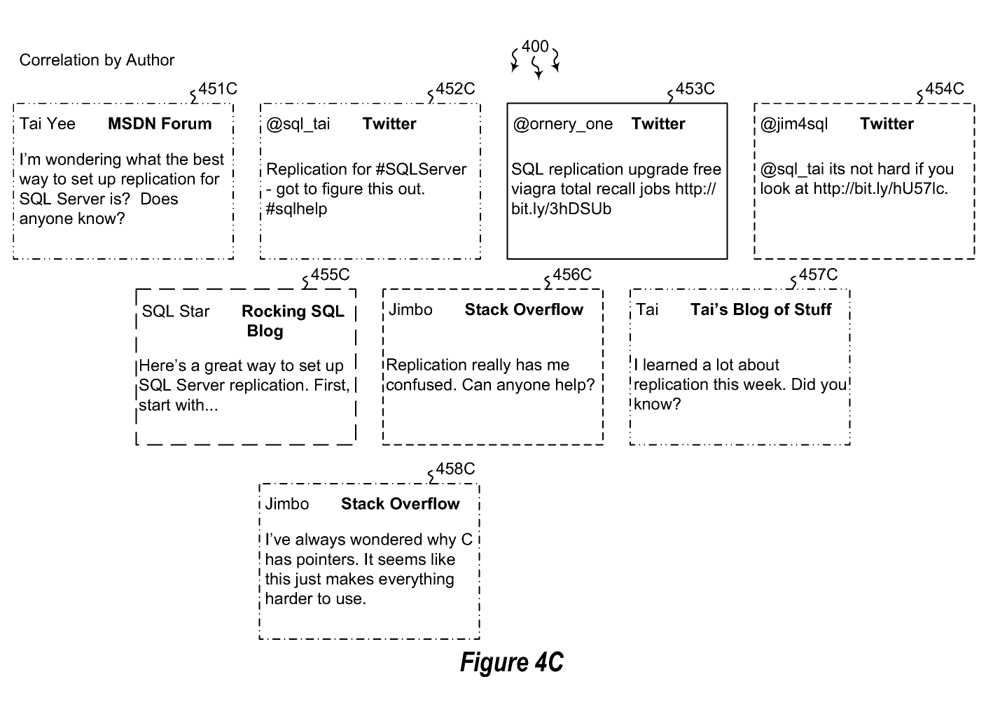

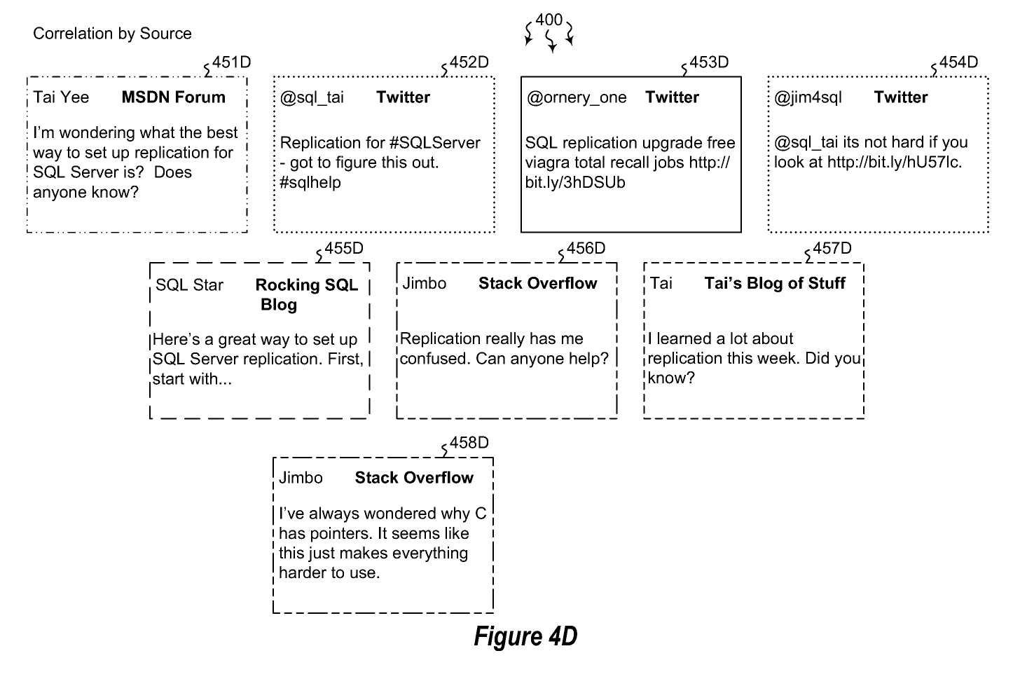

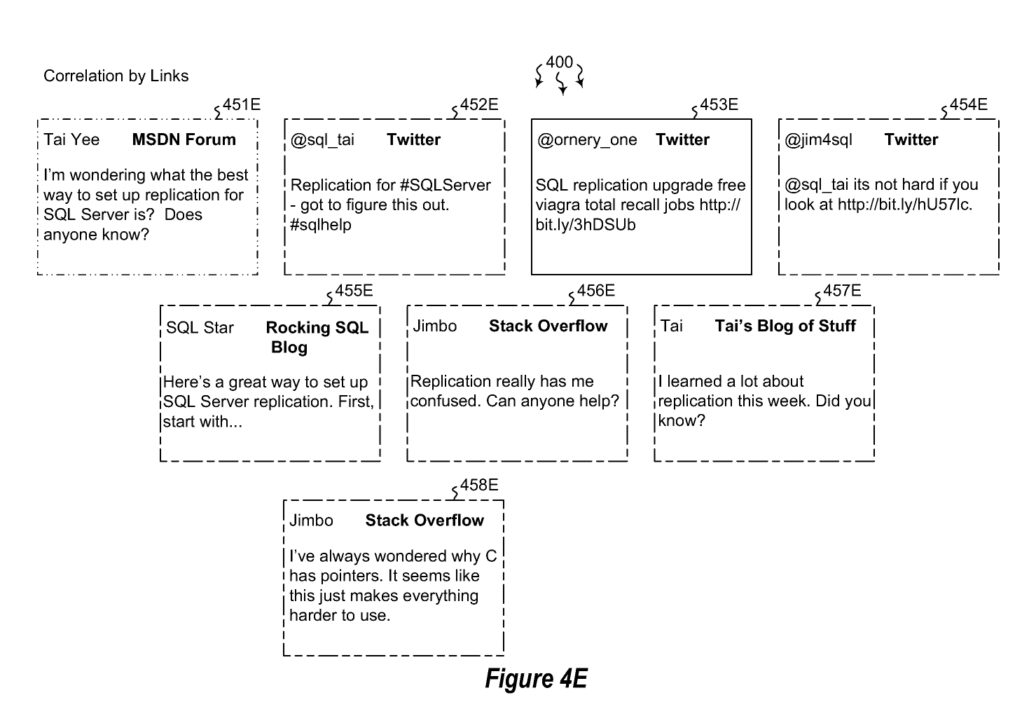

FIG. 3 illustrates a flowchart of a method 300 for providing relevant content to a user. The method 300 will now be described with frequent reference to the components and data of environment 100 of FIGS. 1 and 400 of FIG. 4.

Method 300 includes an act of accessing one or more indices of organized information, wherein the information was organized according to interrelationships between at least two of the following data axes: author, topic and source (act 310). For example, correlation computing module 125 may access any of indices 121A-C to get organized information items 122A-122C. The information items include relationships (e.g. 131-133) along various data axes including author, topic and source. The correlation computing module may then determine correlations between the organized information items across the data axes so that each portion of information has relationship information linking it to other portions of organized information (act 320).

As illustrated in FIGS. 4A-4E, different types of information may be organized based on topic, source, authorship and by link. FIG. 4A shows information content boxes 451A-458A. The information boxes include various types of information, from various different authors, from various different sources and include various different links. Some of the content boxes include either explicit or implicit correlations to other content boxes. These correlations are shown in FIGS. 4B-4E using different content box outlines. Related boxes are shown with the same box outline. For instance, in FIG. 4B, content boxes are shown correlated by topic. Boxes 451B, 452B and 454-457B are shown with a dashed line. These boxes have been determined to be related by topic. Box 453B is shown with a solid line, while box 458B is shown with a styled dash line (dash-dot-dash). These boxes were determined to have unrelated topics.

In FIG. 4C, the content boxes are correlated according to authorship. In FIG. 4C, boxes 451C, 452C and 457C are shown with a styled dash line (dash-dot-dot-dash), indicating an authorship link between those boxes (e.g. those boxes were authored by “Tai”). Boxes 454C and 456C are shown with a styled line that has short dashes, indicating an authorship link between those boxes (e.g. those boxes were authored by “Jimbo”). Boxes 453C (solid), 455C (dashed) and 458C (dash-dot-dash) were each authored by separate authors. Although box 458C was authored by someone with a handle named “Jimbo”, the correlation system can determine, based on other factors, that this data portion was authored by someone other than the author of boxes 454C and 456C.

In FIG. 4D, the content boxes are correlated according to source. In FIG. 4D, boxes 452D and 454D are shown with a styled line (small dots), indicating a source link between those boxes (e.g. the content of those boxes came from “Twitter”). Boxes 456D and 458D are shown with a styled line where the dashes are long-short-short-long, indicating a source link between those boxes (e.g. those boxes came from the website/blog “Stack Overflow”). Boxes 451D (dash-dot-dot-dash), 453D (solid), 455D (dashed) and 457D (short dashes) were gathered from separate sources, and are thus not correlated to other boxes.

FIG. 4E shows content boxes correlated according to explicit or implicit links. Explicit links typically include hyperlinks or other direct links, while implicit links include a mention of another website or content item. In FIG. 4E, boxes 452E and 454-457E are shown with a styled line where the dashes are long-short-long, indicating an explicit or implicit link between those boxes. Boxes 451E (dash-dot-dot-dash), 453E (solid) and 458E (long-short-short-long dashes) are not linked (explicitly or implicitly) to the other content boxes. Thus, FIGS. 4A-4E show how different information can be organized and correlated. It should be noted that while FIGS. 4A-4E illustrate some specific examples of organizing and presenting information, the information gathered from the various internet resources may be organized according to many different data axes and may be presented in many different fashions than those shown here.

Method 300 also includes an act of receiving from a user an identifier (or partial identifier) that is indexed on at least one of the data axes (act 330). For example, computer system 101 may receive identifier 107 from user 105. In some cases, the identifier may be a keyword or search phrase. In other case, the identifier may be a user-selected set of content items (blog posts, web pages, social media messages, etc.). The identifier identifies an association on at least one axis (i.e. topic, source or author). The identifier may then be used as a starting point from which to deduce commonality. Searching module 140 may then perform a search for information items related to the received identifier specified along at least one of the data axes (act 340). Each information item related to the received identifier may be tagged with a tag indicating one or more characteristics about the information item. These characteristics may also be used in the search.

The search may begin along one axis, and determine other correlated items. Some of these items may not have been expected, but are correlated nonetheless. For example, a user may be interested in nutrition facts about a given brand of cereal. The brand of cereal may be provided as an identifier 107. The search may begin looking for information items that are related to that cereal. The search may determine, for example, that other users often bake with that cereal. The search may determine where such recipes may be found (e.g. websites, blogs, etc.) and who invented those recipes. The search may continue down different axes and determine who the followers are of the blogs that have the recipes, and those users have on their blogs, including what other recipes are there and how high those recipes are rated.

The search may also determine what other web sites or tv shows mention this recipe, and may determine, based on ratings or other metadata how a given user appears on the web (e.g. is the person an expert in the field, or just a hobbyist, etc.). The search may also determine whether the source is reputable based on ratings from across the web. Any or all of this information may be returned to the user, (at least in some cases) according to the user's preferences. It should be noted that this is just one example of a nearly infinite array of possible searches, and that it is not intended to limit the types of possible searches.

Method 300 further includes an act of providing the results of the search to the user (act 350). For example, after the search is complete, the results 141 may be returned to the user 105. The results may include data that is related to the provided identifier. The search results may include information items that are related by topic, by author, by source and/or by time. These interrelationships among information items may be used to build a picture of what's happening about a certain event or about a certain product, and how the authors, commenters, web sites and various topics on those sites are related. As such, a search can produce a respectively large amount of data that is closely related to the terms the user is interested in.

Accordingly, methods, systems and computer program products are provided which efficiently correlate internet resources from a variety of sources that are available on or otherwise use the internet. Moreover, methods, systems and computer program products are provided which provide relevant content to a user, based on identifiers supplied by that user.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. At a computer system including at least one processor and a memory, in a computer networking environment including a plurality of computing systems, a computer-implemented method for efficiently correlating internet resources, the method comprising:
an act of gathering one or more portions of information from a plurality of different resources;
an act of organizing the gathered information into multiple different indices according to at least one of the following data axes: author, topic and source; and
an act of computing correlations between the organized information across the data axes such that each portion of information has relationship information linking it to other portions of organized information.

2. The method of claim 1, further comprising an act of intelligently learning which other informational items are to be searched for based on the computed correlations, such that one or more portions of additional data relevant to the gathered data is returned.

3. The method of claim 1, wherein data correlations for each portion of information are weighted according to one or more of a plurality of weighting factors.

4. The method of claim 3, wherein, based on the determined weighting, a further search is performed for a given correlation.

5. The method of claim 1, further comprising implementing a user-configurable statement of relevance which suggests one or more portions of relevant data to a customer.

6. The method of claim 2, wherein the intelligent learning comprises determining the author of a given article, the readers or followers of that author, what other articles are similar and what other sources mention the article.

7. The method of claim 6, further comprising:
receiving from a user one or more keyword topics the user is interested in; and
in response to the received keyword topics, searching for one or more portions of relevant data, refined by author and source.

8. The method of claim 1, wherein the computed correlations create a relationship between an article and an author, between an article responder and the author and further determine, based on the created relationships, the type of relationship between the author and the reader.

9. The method of claim 8, wherein the type of relationship is confirmed by at least one of the author and the article reader, increasing the strength of that correlation.

10. The method of claim 1, wherein a user interface shows, for a given portion of information, a graphical representation of relationship information along at least one of the data axes.

11. The method of claim 1, wherein computing correlations between the organized information across the data axes includes implementing explicit, implicit and behavioral indications of correlation.

12. The method of claim 1, wherein organizing the gathered information into multiple different indices according to topic includes at least one of the following: explicit term matching, synonym or equivalent term matching, subject-verb-object matching, approximate matching and semantic matching.

13. The method of claim 1, wherein organizing the gathered information into multiple different indices according to authorship includes at least one of the following: explicit content declaration, explicit profile declaration, explicit administrative declaration, inference based on profile metadata, inference based on social promotion, inference based on textual analysis and topic, inference based on avatar, picture or video, inference based on social graph, inference based on textual reference, inference based on published location, inference based on activity patterns and topics, and disambiguation of ambiguous authorship.

14. The method of claim 1, wherein organizing the gathered information into multiple different indices according to source includes at least one of the following: site identity, site usage patterns, site topic patterns, site locale, site actions and links to other sources, including direct linking, linking through proxy or link shorteners, linking through mutual linking, linking through indirect linking and linking through textual reference.

15. A computer program product for implementing a method for providing relevant content to a user, the computer program product comprising one or more computer-readable storage media having stored thereon computer-executable instructions that, when executed by one or more processors of the computing system, cause the computing system to perform the method, the method comprising:
an act of accessing one or more indices of organized information, wherein the information was organized according to interrelationships between at least two of the following data axes: author, topic and source;
an act of computing correlations between the organized information across the data axes such that each portion of information has relationship information linking it to other portions of organized information;
an act of receiving from a user at least a partial identifier that is indexed on at least one of the data axes;
an act of initiating a search for information items related to the received identifier specified along at least one of the data axes; and
an act of providing the results of the search to the user.

16. The computer program product of claim 15, wherein the identifier identifies an association on at least one axis.

17. The computer program product of claim 15, wherein the identifier comprises a user-selected set of content items.

18. The computer program product of claim 15, further comprising learning, based on generated correlations, which other items are to be searched for and collected.

19. The computer program product of claim 15, wherein each information item related to the received identifier is tagged with a tag indicating one or more characteristics about the information item.

20. A computer system comprising the following:
one or more processors;
system memory;
one or more computer-readable storage media having stored thereon computer-executable instructions that, when executed by the one or more processors, causes the computing system to perform a method for providing relevant content to a user, the method comprising the following:
an act of accessing one or more indices of organized information, wherein the information was organized according to interrelationships between at least two of the following data axes: author, topic and source;
an act of computing correlations between the organized information across the data axes such that each portion of information has relationship information linking it to other portions of organized information;
an act of receiving from a user at least a partial identifier that is indexed on at least one of the data axes;
an act of initiating a search for information items related to the received identifier specified along at least one of the data axes;
an act of weighting the determined data correlations for each portion of information related to the received identifier, wherein the data correlations are weighted according to one or more of a plurality of weighting factors;
an act of performing a further search for at least one correlation determined to have a sufficiently high correlation weight; and
an act of providing the results of the search to the user.
